(19) United States
(12) Patent Application Publication
(10) Pub. No.: US 2021/0161743 A1
(43) Pub. Date: Jun. 3, 2021

(54) Platform for Lifting an Individual from a Fallen Position

(71) Applicant: Joyce J. Jenkins, Queens Village, NY (US)

(72) Inventor: Joyce J. Jenkins, Queens Village, NY (US)

(21) Appl. No.: 15/734,190

(22) PCT Filed: Jun. 3, 2019
(86) PCT No.: PCT/IB2019/054597

§ 371 Date: Dec. 1, 2020

Related U.S. Application Data
(60) Provisional application No. 62/679,601, filed on Jun. 1, 2018.

(51) Int. Cl. A61G 7/10

(52) U.S. Cl. CPC A61G 7/1011; A61G 7/1021; A61G 7/1074; A61G 7/1088; A61G 7/1038

(57) ABSTRACT

A platform for lifting an individual from a fallen position is designed to be slid beneath the body of a user and transitions between a collapsed and an extended configuration. The extended configuration raises the individual to a seated position. The platform for lifting an individual has a base platform, a lifting platform, a folding wedge, a set of collapsible supports, and a lift-control assembly. The folding wedge is hingedly connected in between the base platform and the lifting platform so that the folding wedge forms a ramp, while in the collapsed configuration, that is slid beneath the body of the downed individual. The collapsible supports are connected in between the base platform and the lifting platform. The lift-control assembly is mounted in between the base platform and the lifting platform and generates the force required to transition the platform for lifting an individual between the extended and collapsed configurations.

The current application is a 371 of international Patent Cooperation Treaty (PCT) application PCT/IB2019/054597 filed on Jun. 6, 2019.

### FIELD OF THE INVENTION

The present invention relates generally to an emergency assistance device. More particularly, the present invention relates to a mechanized platform that is used to raise an individual from a prone position into a seated position.

### BACKGROUND OF THE INVENTION

There are many situations where an individual who has fallen is unable to lift themselves and requires outside assistance. If an obese individual must be moved by emergency personnel, it may be difficult to lift the obese person without assistance. In both of these situations, a lift-assist device for individuals would significantly improve the quality of life for all parties involved.

An alternative use case would involve an individual who is alone, not injured but needs minimal assistance to get up from the floor. Similarly, the present invention can be used by others to quickly assist an individual in any situation where the invention would serve as a sure method for a quick recovery. Further, the present invention is intended to be used as an everyday tool that does not necessitate an emergency to be deployed.

### Falling in America

We know that the rate of falls in America increases as the population ages. There are yet many more individuals who fall as a result of a disability at any age. Falls often result in catastrophic injuries. Because of this, there are numerous services that are designed to get help to an individual who has fallen. These services primarily follow a similar process:
A. Person falls and is alone or with an individual who cannot get them up.
B. Pushes the alert.
C. Remote operator responds to confirm the need.
D. Contacts are then alerted.
E. Help is dispatched.
F. EMS in route.
G. Enters location.
H. Assistance is provided.

However, there are also many times when falls, which while traumatic, do not incapacitate the person. These may occur in the home and the individual figures out a way to get up.

A different scenario with the aid of the invention would be as follows:
A. Person falls and is alone or with an individual who cannot get them up.
B. Runs through a checklist and ensures that nothing is broken.
C. Slides to nearest device.
D. Rolls onto device
E. Lifts to a seated height.
F. Transfers to a chair

The value-added by the invention is the individual's ability to recover on their own in a shorter amount of time. Further, the individual does not incur any additional discomfort while waiting for assistance to come.

The present invention provides such a lift-assist device. Specifically, the present invention provides a lift-assist device that makes use of a spring-based strut assembly to lift the body of a user off of the floor. Further, the present invention is designed to maintain the body of the user in a seated position. The present invention further facilitates lifting the user by providing a wedge system that can be slid under the user's body while the user is on the floor. As the present invention lifts the user into the seated position, the wedge becomes flattened. Thus, easing the legs of the user into the seated position. It is an aim of the present invention to provide a portable system that can be easily accessed by the user who has fallen.

### BRIEF DESCRIPTION OF THE DRAWINGS

FIG. 1 is a right perspective view of the present invention in an extended configuration.

FIG. 2 is a left perspective view of the present invention.

FIG. 3 is a right-side view of the present invention.

FIG. 4 is a right perspective view of the present invention showing the backrest in an upright configuration.

FIG. 5 is a right perspective view of the present invention in a collapsed configuration.

FIG. 6 is a right perspective view of an alternative embodiment of the present invention in an extended configuration.

FIG. 7 is a rear view of the alternative embodiment of the present invention.

### DETAIL DESCRIPTIONS OF THE INVENTION

All illustrations of the drawings are for the purpose of describing selected versions of the present invention and are not intended to limit the scope of the present invention.

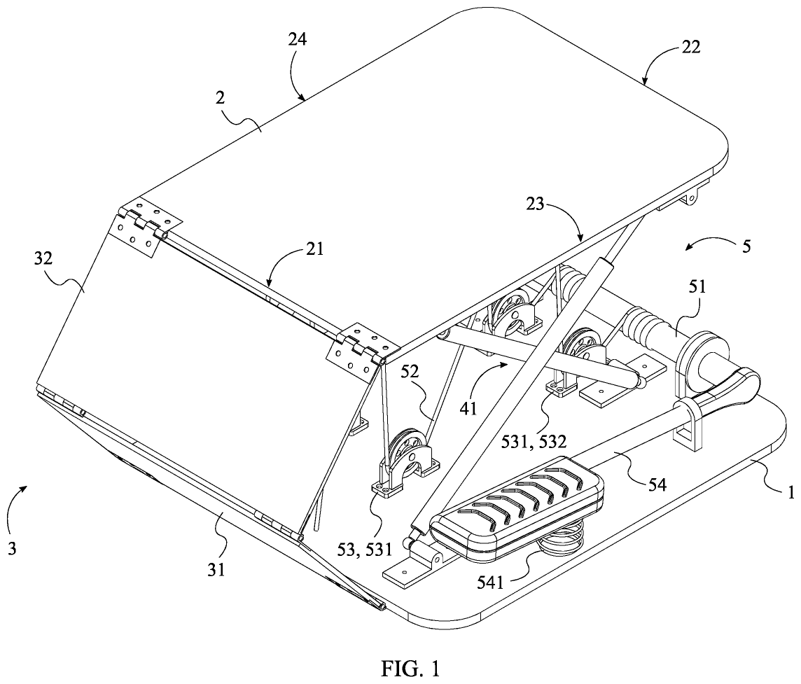

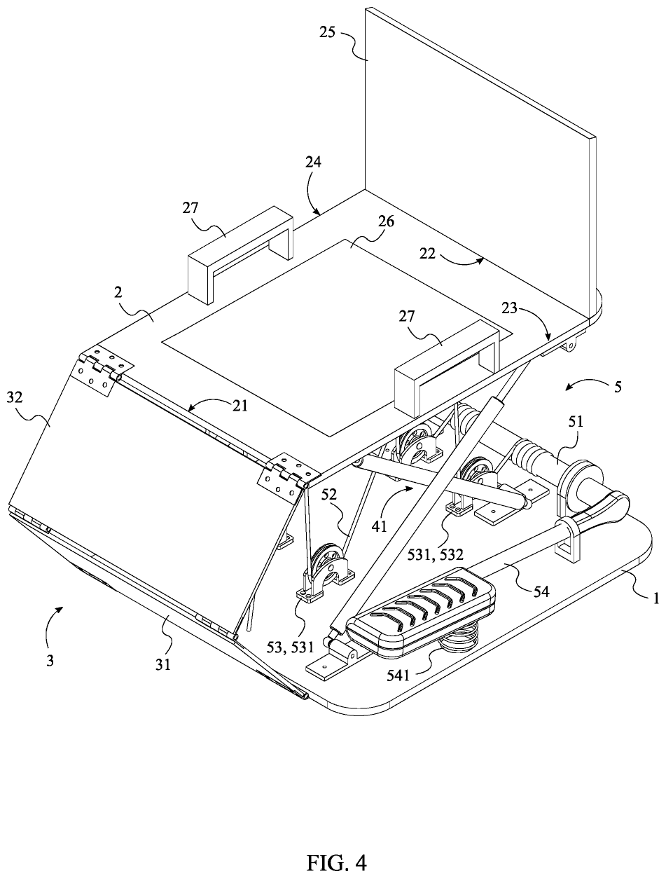

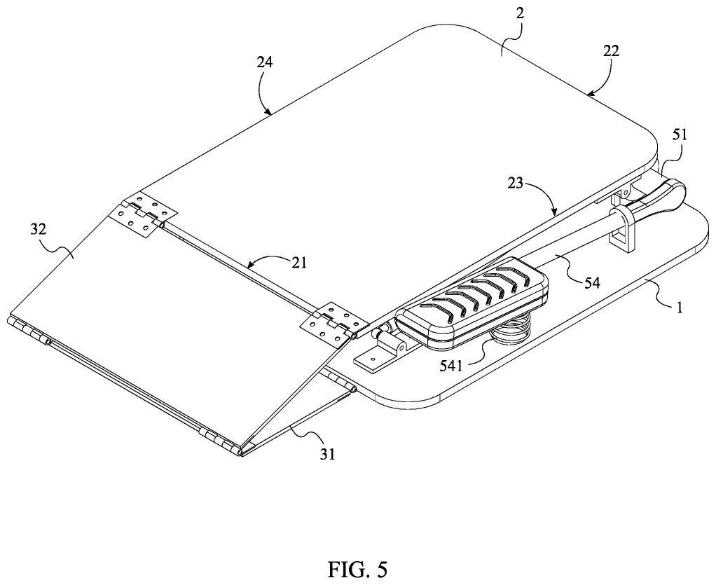

Referring to FIG. 1 through FIG. 7, the present invention, the platform for lifting an individual from a fallen position, is a device that is used to lift a user who has fallen over. Specifically, the present invention is a lift that can be inserted beneath the user while the user is lying on the ground. Once inserted beneath the user, the lift is activated, and the user is raised to a seated position. Specifically, the present invention transitions between a collapsed configuration and an extended configuration. In the collapsed configuration, the present invention is designed to be slid beneath the body of the user while the user is positioned on the ground. In the extended configuration, the present invention is designed to lift the user into the seated position. Further, the user is able to adjust the height to which the present invention extends. Thus, enabling the present invention to be used with users of varying shape and size.

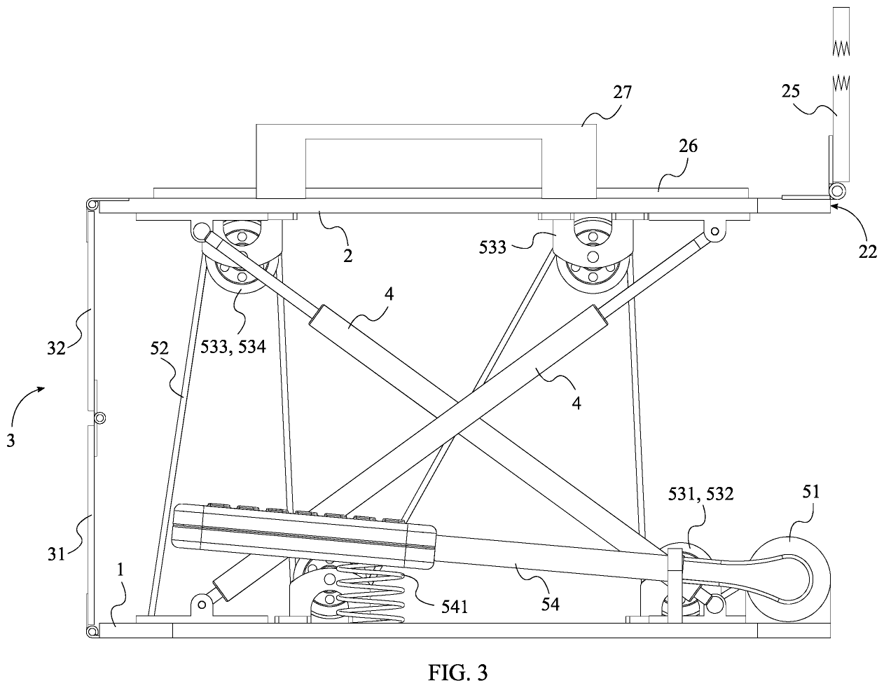

Referring to FIG. 1 and FIG. 3, as described above, the present invention is designed to be a user-controlled lift. To accomplish this, the present invention comprises a base platform 1, a lifting platform 2, a folding wedge 3, a plurality of collapsible supports 4, and a lift-control assembly 5. The base platform 1 is a rigid platform that forms the structural foundation for the remaining components of the present invention. The lifting platform 2 is a rigid panel that supports the weight of the user when the present invention is placed beneath the user. That is, the lifting platform 2 forms a seat on which the user rests when the present invention lifts the user into the seated position. The folding wedge 3 is an articulated member that can transition between a ramp and a planar surface. Additionally, the folding wedge 3 is laterally and hingedly connected to the base platform 1. Further, the folding wedge 3 is laterally and hingedly connected to the lifting platform 2. As a result, the folding wedge 3 forms a ramp while the present invention is in the collapsed configuration. Further, the folding wedge 3 forms a planar sidewall while the present invention is in the extended configuration. Preferably, the present invention is designed such that a person who is alone will be able to slide onto the invention and then be safely transferred to a chair or to a standing position from the seated position. Thus, facilitating assisting the user who has fallen. As the present invention transitions into the extended configuration, the folding wedge 3 forms a lateral surface that facilitates maintaining the user in the seated position. Preferably, the folding wedge 3 comprises a first panel 31 and a second panel 32. The first panel 31 is hingedly connected to the base platform 1. Additionally, the second panel 32 is hingedly connected to the first panel 31, opposite to the base platform 1. Further, the second panel 32 is hingedly connected to a first widthwise edge 21 of the lifting platform 2, opposite to the first panel 31. Consequently, the folding wedge 3 is able to be slid beneath the body of the user while the present invention is in the collapsed configuration.

Referring to FIG. 1 and FIG. 3, the plurality of collapsible supports 4 is a collection of support structures that can extend or contract as the present invention is transitioned between the extended configuration and the collapsed configuration. Specifically, the plurality of collapsible supports 4 is mounted in between the base platform 1 and the lifting platform 2. Accordingly, the plurality of collapsible struts limits the distance the lifting platform 2 can be displaced relative to the base platform 1. Further, the plurality of collapsible supports 4 provides the rigidity required to support a user who may be squirming or awkwardly seated. The present invention is designed with a system that enables the user to control the distance and the rate at which the lifting platform 2 is moved. To accomplish this, the lift-control assembly 5 is an actuation system that governs the distance which the lifting platform 2 is displaced. Specifically, the lift-control assembly 5 is operatively coupled between the base platform 1 and the lifting platform 2. Further, the lift-control assembly 5 generates the force required to modify the vertical distance between the base platform 1 and the lifting platform 2. Accordingly, the lift-control assembly 5 is a mechanical system that provides the requisite forces for transitioning the present invention between the collapsed configuration and the extended configuration. Additionally, the lift-control assembly 5 is positioned offset from the plurality of collapsible supports 4. Thus positioned, the components of the lift control assembly do not hinder the collapsible functionality of the plurality of collapsible supports 4.

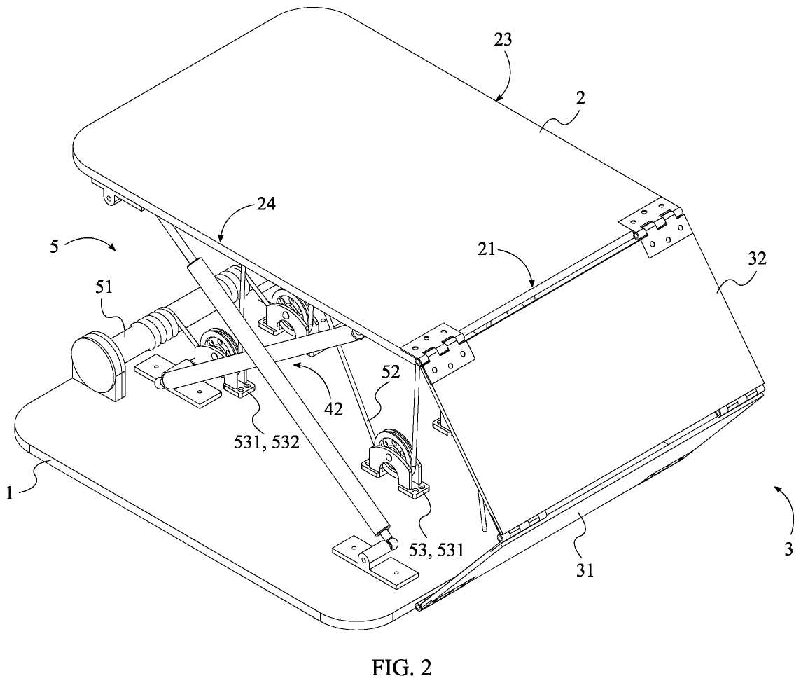

Referring to FIG. 1, FIG. 2, and FIG. 3, in the preferred embodiment of the present invention the lift-control assembly 5 works in concert with the plurality of collapsible supports 4 to provide the lifting force required to transition the present invention between the collapsed configuration and the extended configuration. To that end, the plurality of collapsible supports 4 comprises at least one first cross-protracting strut 41 and at least one second cross-protracting strut 42. The first cross-protracting strut 41 and the second cross-protracting strut 42 are actuation members that provide the requisite force for transitioning the present invention from the collapsed configuration to the extended configuration. Preferably, the first cross-protracting strut 41 and the second cross-protracting strut 42 are each made of two gas springs that provide the force required to transition the present invention into the extended configuration, by extending. Alternatively, the first cross-protracting strut 41 and the second cross-protracting strut 42 are designed using linear actuators including, but not limited to, pistons and hydraulic cylinders. The first cross-protracting strut 41 is positioned offset from the second cross-protracting across the lifting platform 2. Specifically, the first cross-protracting strut 41 is positioned along a first lengthwise edge 23 of the lifting platform 2. The second cross-protracting strut 42 is positioned along a second lengthwise edge 24 of the lifting platform 2, opposite to the first lengthwise edge 23. Additionally, the lift-control assembly 5 is positioned in between the first cross-protracting strut 41 and the second cross-protracting strut 42. Thus positioned, the lift assembly, is able to provide an evenly distributed counterforce to the first cross-protracting strut 41 and the second cross-protracting strut 42.

Referring to FIG. 1 and FIG. 3, in the preferred embodiment of the present invention, the lift-control assembly 5 provides a counterforce that compresses the first cross-protracting strut 41 and the second cross-protracting strut 42 when transitioning the present invention from the extended configuration into the collapsed configuration. To achieve this functionality, the lift-control assembly 5 comprises a winch 51, at least one tensioning cable 52, and at least one pulley 53. The winch 51 is mounted onto the base platform 1. Additionally, the tensioning cable 52 is tethered in between the winch 51 and the lifting platform 2. As a result, the winch 51 is able to control the amount of the tensioning cable 52 that is payed out or reeled in. Thus, controlling the distance the present invention is extended or collapsed. Additionally, the winch 51 is preferably a crank-operated device that can be controlled by the user rotating a crankshaft. When the user wants to transition the present invention from the collapsed configuration to the extended configuration, the user disengages the winch 51. When the user disengages the winch 51, the plurality of cross-protracting struts moves the lifting panel away from the base platform 1. The user can reengage the winch 51 at any time to limit the amount of the tensioning cable 52 that is payed out. Thus, limiting the distance the lifting platform 2 is able to travel. To transition the present invention from the extended configuration into the collapsed configuration, the user actuates the winch 51 by rotating the crankshaft and reeling in the tensioning cable 52. As the tensioning cable 52 is reeled in, the lifting platform 2 is drawn toward the base platform 1. Preferably, the present invention further comprises a lever 54 and a lever actuator 541. The lever 54 is operatively coupled to the winch 51, wherein actuating the lever 54 causes the winch 51 to pay out or reel in the tensioning cable 52. Consequently, the user is able to actuate the winch 51 by rotating the lever 54. The lever 54 is preferably coupled to the winch 51 via a ratcheting system that enables the user to lock the winch 51 in a desired position, such that the lifting platform 2 is retained at a desired height, relative to the base platform 1. The lever actuator 541 is a mechanical system that assists the user when rotating the lever 54 to pay out or reel in the tensioning cable 52. In an alternative embodiment of the present invention, the lift-control assembly 5 is a motorized system that uses a motor to control the transition between the collapsed configuration and the extended configuration. In this embodiment, a remote controller is communicably coupled to the lift-control assembly 5. As a result, the user is able to electronically control the displacement of the lifting platform 2 relative to the base platform 1.

Referring to FIG. 1 and FIG. 3, the pulley 53 is mounted onto the base platform 1 and positioned offset from the winch 51. Additionally, the pulley 53 is positioned in between the winch 51 and the lifting platform 2 along the tensioning cable 52. Consequently, the tensioning cable 52 is routed through the pulley 53, such that the pulley 53 is positioned along the length of the tensioning cable 52, in between the winch 51 and lifting platform 2. Accordingly, the pulley 53 provides a mechanical advantage that decreases the amount of force the winch 51 is required to provide. In an alternative embodiment, the at least one pulley 53 comprises a plurality of base pulleys 531 and a plurality of lift pulleys 533. Additionally, the at least one tensioning cable 52 comprises a plurality of cables 52. The plurality of base pulleys 531 is mounted onto the base platform 1. Likewise, the plurality of lift pulleys 533 is mounted onto the lifting platform 2. Additionally, the plurality of base pulleys 531 and the plurality of lift pulleys 533 are positioned in between the base platform 1 and the lifting platform 2. Further, each of the plurality of cables 52 is routed through at least one corresponding base pulley 532 from the plurality of base pulleys 531. Similarly, each of the plurality of cables 52 is routed through at least one corresponding lift pulley 534 from the plurality of lift pulleys 533. Accordingly, the plurality of lift pulleys 533 and the plurality of base pulleys 531 work in concert to reduce the amount of force the winch 51 must exert when transitioning the present invention from the extended configuration to the collapsed configuration.

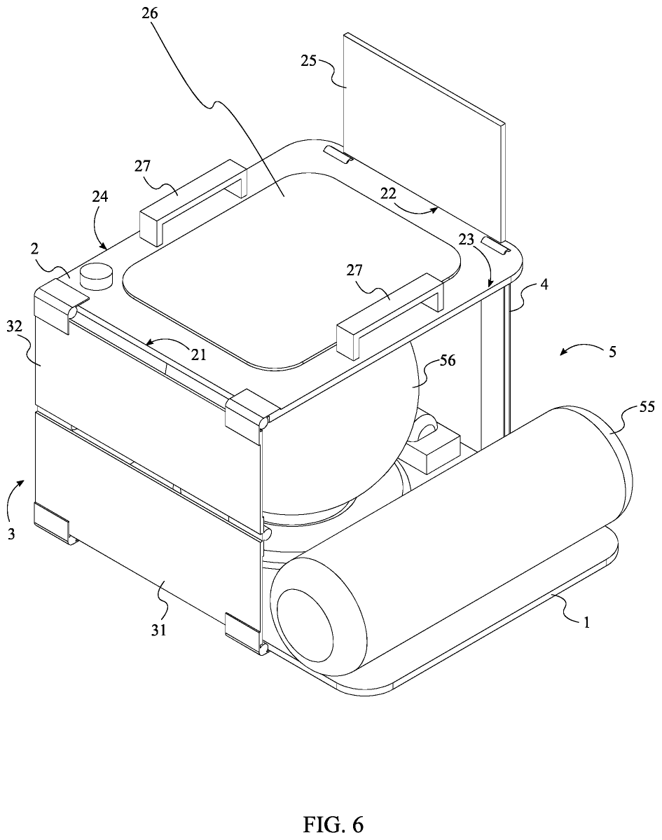

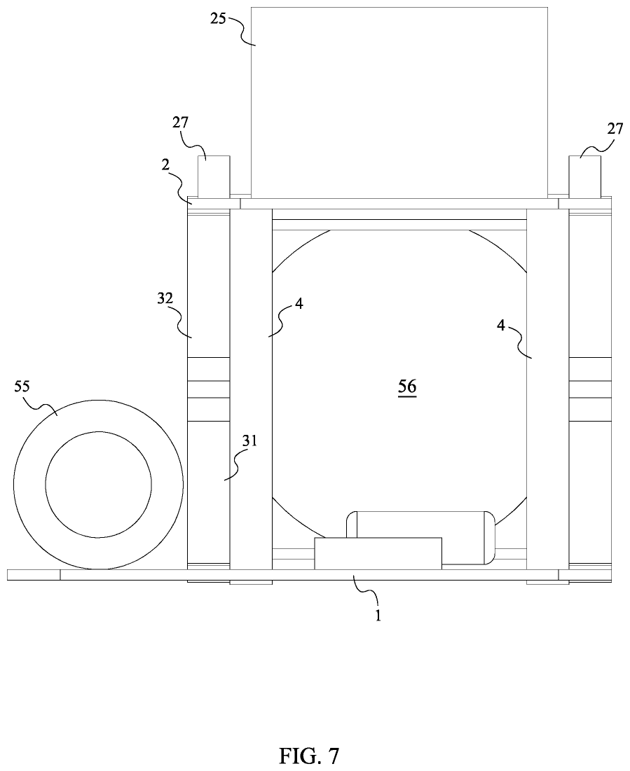

Referring to FIG. 1, FIG. 6, and FIG. 7, in a separate alternative embodiment, the lift-control assembly 5 makes use of an active lift system to generate the force required to transition the present invention between the extended configuration and the collapsed configuration. To achieve this functionality, the lift-control assembly 5 comprises a pump 55 and an inflatable bladder 56. The pump 55 is mounted onto the base platform 1 so that the pump 55 remains in a fixed position while the lifting platform 2 transitions between the collapsed configuration and the extended configuration. Additionally, the pump 55 is in fluid communication with the inflatable bladder 56. As a result, the pump 55 is used to inflate the inflatable bladder 56. Some embodiments of the present invention replace the pump 55 with a compressor to inflate the inflatable bladder 56. The inflatable bladder 56 is mounted in between the base platform 1 and the lifting platform 2. Accordingly, the inflatable bladder 56 vertically displaces the lifting platform 2, relative to the base platform 1, when inflated or deflated. That is, the pump 55 and the inflatable bladder 56 work in concert to transition the present invention between the collapsed configuration and the extended configuration. When the pump 55 inflates the inflatable bladder 56 the lifting platform 2 is moved away from the base platform 1. As the inflatable bladder 56 deflates the lifting platform 2 is moved closer to the base platform 1. Thus, the position of the lifting platform 2, relative to the base platform 1, is directly proportional to the amount of air that is retained within the inflatable bladder 56. In some embodiments, the inflatable bladder is an accordion-type structure that collapses onto itself when deflated. Embodiments of the present invention are designed with an electronic control system and an onboard power supply that enable the present invention to be used in a variety of conditions.

Referring to FIG. 1, FIG. 3, and FIG. 6, the present invention is designed to act as a potentially life-saving device that increases the quality of life for the user. To that end, the present invention further comprises a backrest 25, a cushion 26, and a plurality of handles 27. The backrest 25 is hingedly connected to a second widthwise edge 22 of the lifting platform 2, opposite to the folding wedge 3. As a result, the user may unfold the backrest 25 to facilitate the establishment of a comfortable seat. Additionally, the backrest 25 further supports the user when being moved into a seated position by the present invention. The backrest 25 is designed to be folded away for storing and transporting the present invention. The cushion 26 is connected adjacent to the lifting platform 2, opposite to the plurality of collapsible supports 4. Thus positioned, the cushion 26 provides a comfortable seat for the user resting on the lifting platform 2. The plurality of handles 27 is connected adjacent to the lifting platform 2, opposite to the plurality of collapsible supports 4. Additionally, the plurality of handles 27 is positioned offset from the cushion 26. Consequently, the plurality of handles 27 function as supports that enable the user to remain seated, securely, while the present invention is transitioned between the collapsed configuration and the extended configuration. Some embodiments of the present invention are equipped with a seatbelt that further secures the user that is seated on the lifting platform 2. Further embodiments are designed with detachable handles 27 that can be removed or swiveled out of position to accommodate various mounting and dismounting strategies, or transfer points. Additional embodiments are designed with wireless communication systems that enable the present invention to be controlled by a remote server or user. Further embodiments of the present invention are designed with a mobility system and electronic control system. These embodiments act as semi-autonomous drones that are capable of moving toward, and lifting, the fallen individual without external intervention. Alternatively, the autonomous drone can be controlled by a remotely positioned individual.

Although the invention has been explained in relation to its preferred embodiment, it is to be understood that many other possible modifications and variations can be made without departing from the spirit and scope of the invention as hereinafter claimed.

What is claimed is:

1. A platform for lifting an individual from a fallen position comprising:
a base platform;
a lifting platform;
a folding wedge;
a plurality of collapsible supports;
a lift-control assembly;
the folding wedge being laterally and hingedly connected to the base platform;
the folding wedge being laterally and hingedly connected to the lifting platform, opposite to the base platform;
the plurality of collapsible supports being mounted in between the base platform and the lifting platform;
the lift-control assembly being operatively coupled between the base platform and the lifting platform, wherein the lift-control assembly generates the force required to modify the vertical distance between the base platform and the lifting platform; and
the lift-control assembly being positioned offset from the plurality of collapsible supports.

2. The platform for lifting an individual from a fallen position as claimed in claim 1 comprising:
the folding wedge comprising a first panel and a second panel;
the first panel being hingedly connected to the base platform;
the second panel being hingedly connected to the first panel, opposite to the base platform; and
the second panel being hingedly connected to a first widthwise edge of the lifting platform, opposite to the first panel.

3. The platform for lifting an individual from a fallen position as claimed in claim 1 comprising:
the plurality of collapsible supports comprising at least one first cross-protracting strut and at least one second cross-protracting strut;
the first cross-protracting strut being positioned offset from the second cross-protracting strut across the lifting platform; and
the lift-control assembly being positioned in between the first cross-protracting strut and the second cross-protracting strut.

4. The platform for lifting an individual from a fallen position as claimed in claim 3 comprising:
a first lengthwise edge;
a second lengthwise edge;
the first lengthwise edge being positioned opposite to the second lengthwise edge across the lifting platform;
the first cross-protracting strut being positioned along the first lengthwise edge; and
the second cross-protracting strut being positioned along the second lengthwise edge.

5. The platform for lifting an individual from a fallen position as claimed in claim 1 comprising:
the lift-control assembly comprising a winch, at least one tensioning cable, and at least one pulley;
the winch being mounted onto the base platform;
the tensioning cable being tethered in between the winch and the lifting platform;
the pulley being mounted onto the base platform;
the pulley being positioned offset from the winch across the base platform; and
the pulley being positioned in between the winch and the lifting platform along the tensioning cable.

6. The platform for lifting an individual from a fallen position as claimed in claim 5 comprising:
the at least one pulley comprising a plurality of base pulleys and a plurality of lift pulleys;
the at least one tensioning cable being a plurality of cables;
the plurality of base pulleys being mounted onto the base platform;
the plurality of lift pulleys being mounted onto the lifting platform;
the plurality of base pulleys being positioned in between the base platform and the lifting platform;
the plurality of lift pulleys being positioned in between the base platform and the lifting platform;
each of the plurality of cables being routed through at least one corresponding base pulley from the plurality of base pulleys; and
each of the plurality of cables being routed through at least one corresponding lift pulley from the plurality of lift pulleys.

7. The platform for lifting an individual from a fallen position as claimed in claim 5 comprising:
a lever; and
the lever being operatively coupled to the winch, wherein actuating the lever causes the winch to play out or reel in the tensioning cable.

8. The platform for lifting an individual from a fallen position as claimed in claim 7 comprising:
a lever actuator; and
the lever actuator being connected in between the lever and the base platform.

9. The platform for lifting an individual from a fallen position as claimed in claim 1 comprising:
the lift-control assembly comprising a pump and an inflatable bladder;
the pump being mounted onto the base platform;
the pump being in fluid communication with the inflatable bladder; and
the inflatable bladder being mounted in between the base platform and the lifting platform.

10. The platform for lifting an individual from a fallen position as claimed in claim 1 comprising:
a backrest; and
the backrest being hingedly connected to a second widthwise edge of the lifting platform, opposite to the folding wedge.

11. The platform for lifting an individual from a fallen position as claimed in claim 1 comprising:
a cushion; and
the cushion being connected adjacent to the lifting platform, opposite to the plurality of collapsible supports.

12. The platform for lifting an individual from a fallen position as claimed in claim 1 comprising:
a plurality of handles; and
the plurality of being mounted onto to the lifting platform, opposite to the plurality of collapsible supports.

13. A platform for lifting an individual from a fallen position comprising:
a base platform;
a lifting platform;
a folding wedge;
a plurality of collapsible supports;
a lift-control assembly;
a backrest;
a cushion;
a plurality of handles;
the folding wedge comprising a first panel and a second panel;
the folding wedge being laterally and hingedly connected to the base platform;
the folding wedge being laterally and hingedly connected to the lifting platform, opposite to the base platform;
the plurality of collapsible supports being mounted in between the base platform and the lifting platform;
the lift-control assembly being operatively coupled between the base platform and the lifting platform, wherein the lift-control assembly generates the force required to modify the vertical distance between the base platform and the lifting platform;
the lift-control assembly being positioned offset from the plurality of collapsible supports;
the backrest being hingedly connected to a second widthwise edge of the lifting platform, opposite to the folding wedge;
the cushion being connected adjacent to the lifting platform, opposite to the plurality of collapsible supports;
the plurality of being mounted onto to the lifting platform, opposite to the plurality of collapsible supports;
the first panel being hingedly connected to the base platform;
the second panel being hingedly connected to the first panel, opposite to the base platform; and
the second panel being hingedly connected to a first widthwise edge of the lifting platform, opposite to the first panel.

14. The platform for lifting an individual from a fallen position as claimed in claim 13 comprising:
the plurality of collapsible supports comprising at least one first cross-protracting strut and at least one second cross-protracting strut;
the first cross-protracting strut being positioned offset from the second cross-protracting strut across the lifting platform; and
the lift-control assembly being positioned in between the first cross-protracting strut and the second cross-protracting strut.

15. The platform for lifting an individual from a fallen position as claimed in claim 14 comprising:
a first lengthwise edge;
a second lengthwise edge;
the first lengthwise edge being positioned opposite to the second lengthwise edge across the lifting platform;
the first cross-protracting strut being positioned along the first lengthwise edge; and
the second cross-protracting strut being positioned along the second lengthwise edge.

16. The platform for lifting an individual from a fallen position as claimed in claim 13 comprising:
the lift-control assembly comprising a winch, at least one tensioning cable, and at least one pulley;
the winch being mounted onto the base platform;
the tensioning cable being tethered in between the winch and the lifting platform;
the pulley being mounted onto the base platform;
the pulley being positioned offset from the winch across the base platform; and
the pulley being positioned in between the winch and the lifting platform along the tensioning cable.

17. The platform for lifting an individual from a fallen position as claimed in claim 16 comprising:
the at least one pulley comprising a plurality of base pulleys and a plurality of lift pulleys;
the at least one tensioning cable being a plurality of cables;
the plurality of base pulleys being mounted onto the base platform;
the plurality of lift pulleys being mounted onto the lifting platform;
the plurality of base pulleys being positioned in between the base platform and the lifting platform;
the plurality of lift pulleys being positioned in between the base platform and the lifting platform;
each of the plurality of cables being routed through at least one corresponding base pulley from the plurality of base pulleys; and
each of the plurality of cables being routed through at least one corresponding lift pulley from the plurality of lift pulleys.

18. The platform for lifting an individual from a fallen position as claimed in claim 17 comprising:
a lever; and
the lever being operatively coupled to the winch, wherein actuating the lever causes the winch to play out or reel in the tensioning cable.

19. The platform for lifting an individual from a fallen position as claimed in claim 18 comprising:
a lever actuator; and
the lever actuator being connected in between the lever and the base platform.

20. The platform for lifting an individual from a fallen position as claimed in claim 13 comprising:
the lift-control assembly comprising a pump and an inflatable bladder;
the pump being mounted onto the base platform; and
the pump being in fluid communication with the inflatable bladder;
the inflatable bladder being mounted in between the base platform and the lifting platform.
